(19) United States
(12) Patent Application Publication
(10) Pub. No.: US 2026/0104748 A1
(43) Pub. Date: Apr. 16, 2026

(54) HILITE: HIERARCHICAL AND LIGHTWEIGHT IMITATION LEARNING FOR POWER MANAGEMENT OF EMBEDDED SOCS

(71) Applicants: Arizona Board of Regents on behalf of Arizona State University, Scottsdale, AZ (US); Arizona Board of Regents on Behalf of the University of Arizona, Tucson, AZ (US); Board of Regents, The University of Texas System, Austin, TX (US); Carnegie Mellon University, Pittsburgh, PA (US)

(72) Inventors: Umit OGRAS, Madison, WI (US); Radu MARCULESCU, Austin, TX (US); Ali AKOGLU, Tucson, AZ (US); Chaitali CHAKRABARTI, Tempe, AZ (US); Daniel BLISS, Phoenix, AZ (US); Samet Egemen ARDA, Chandler, AZ (US); Anderson SARTOR, La Jolla, CA (US); Nirmal KUMBHARE, Tucson, AZ (US); Anish KRISHNAKUMAR, Austin, TX (US); Joshua MACK, Tucson, AZ (US); Ahmet GOKSOY, Madison, WI (US); Sumit MANDAL, Madison, WI (US)

(21) Appl. No.: 19/241,102

(22) Filed: Jun. 17, 2025

Related U.S. Application Data
(63) Continuation of application No. 18/249,876, now Pat. No. 12,332,707.
(60) Provisional application No. 63/104,269, filed on Oct. 22, 2020.

(51) Int. Cl. G06F 1/26

(52) U.S. Cl. CPC G06F 1/26

(57) ABSTRACT

Hierarchical and lightweight imitation learning (IL) for power management of embedded systems-on-chip (SoCs), also referred to herein as HiLITE, is provided. Modern SoCs use dynamic power management (DPM) techniques to improve energy efficiency. However, existing techniques are unable to efficiently adapt the runtime decisions considering multiple objectives (e.g., energy and real-time requirements) simultaneously on heterogeneous platforms. To address this need, embodiments described herein propose HiLITE, a hierarchical IL framework that maximizes energy efficiency while satisfying soft real-time constraints on embedded SoCs. This approach first trains DPM policies using IL; then, it applies a regression policy at runtime to minimize deadline misses. HiLITE improves the energy-delay product by 40% on average, and reduces deadline misses by up to 76%, compared to state-of-the-art approaches. In addition, the trained policies not only achieve high accuracy, but also have negligible prediction time overhead and small memory footprint.

### RELATED APPLICATIONS

The present application is a continuation of U.S. patent application Ser. No. 18/249,876, filed Apr. 20, 2023, which is a 35 U.S.C. § 371 national phase filing of International Application No. PCT/US2021/056275, filed Oct. 22, 2021, and claims the benefit of U.S. Provisional Patent Application No. 63/104,269, filed Oct. 22, 2020, wherein the entire contents of the foregoing applications are hereby incorporated by reference herein.

### GOVERNMENT SUPPORT

This invention was made with government support under FA8650-18-2-7860 awarded by the Defense Advanced Research Projects Agency. The government has certain rights in the invention.

### FIELD OF THE DISCLOSURE

The present disclosure is related to power management of processing devices.

### BACKGROUND

Systems-on-chip (SoCs) should be designed to meet aggressive performance requirements while coping with limited battery capacity, thermal design power (TDP), and real-time (RT) constraints. A step in this direction consists of exploiting heterogeneity, e.g., using big cores when high performance is needed and switching to little cores otherwise. In addition, techniques such as dynamic voltage and frequency scaling (DVFS) and power gating (PG) can be used at runtime to manage the power consumption of SoCs. However, the design space of runtime decisions explodes combinatorially with the number of cores, frequency levels, and power states. Additionally, current platforms serve a wide range of applications with distinct characteristics and requirements. The extensive design space and the growing variety of applications call for new runtime techniques to efficiently manage the power and performance of embedded heterogeneous platforms.

Prior works on heterogeneous platforms use machine learning to improve the energy efficiency with respect to dynamic power management (DPM) techniques present in commercial SoCs. However, these studies do not take RT constraints and PG into consideration. Likewise, hierarchical power management techniques do not target these metrics; instead, they use reinforcement learning (RL) and specialized heuristics for energy optimization in homogeneous platforms. Targeting additional constraints such as RT is non-trivial, and if the DPM techniques do not apply specific mechanisms to address these constraints, they deliver suboptimal results. For instance, such an approach results in high deadline misses for RT applications.

Some previous works use RL to optimize for RT constraints. However, RL increases exponentially in size as the state and action spaces increase. Instead, imitation learning (IL) is used by these works to train a DPM policy that efficiently explores a large design space. One approach considers RT and PG, but simply selects between two heuristic-based policies for DVFS and PG. Each of these previous approaches only consider homogeneous platforms and often single-core processors, hence, such techniques are not able to efficiently optimize a heterogeneous SoC. Therefore, given the constraints in current SoCs, new techniques that are able to adapt the runtime decisions to different objectives and constraints are needed.

### SUMMARY

Hierarchical and lightweight imitation learning (IL) for power management of embedded systems-on-chip (SoCs), also referred to herein as HiLITE, is provided. Modern SoCs use dynamic power management (DPM) techniques to improve energy efficiency. However, existing techniques are unable to efficiently adapt the runtime decisions considering multiple objectives (e.g., energy and real-time requirements) simultaneously on heterogeneous platforms. To address this need, embodiments described herein propose HiLITE, a hierarchical IL framework that maximizes energy efficiency while satisfying soft real-time constraints on embedded SoCs.

This approach first trains DPM policies using IL; then, it applies a regression policy at runtime to minimize deadline misses. HiLITE improves the energy-delay product by 40% on average, and reduces deadline misses by up to 76%, compared to state-of-the-art approaches. In addition, the trained policies not only achieve high accuracy, but also have negligible prediction time overhead and small memory footprint.

An exemplary embodiment provides a method for hierarchical power management in a heterogeneous SoC. The method includes obtaining a plurality of application tasks for execution by the heterogeneous SoC, obtaining IL policies for reducing an energy-delay product during execution of the plurality of application tasks, and applying the IL policies at a first level to predict power requirements for executing the plurality of application tasks.

Another exemplary embodiment provides a DPM framework. The DPM framework includes a heterogeneous SoC simulator configured to simulate execution of a plurality of application tasks by a heterogeneous SoC and a power manager configured to apply IL-based power policies to the heterogeneous SoC during execution of the plurality of tasks. The power manager includes a first level configured to make processing power decisions based on predicting power requirements for implementing the IL-based power policies and a second level configured to adjust the first level processing power decisions during run-time.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary embodiment of hierarchical and lightweight imitation learning (IL) for power management of embedded systems-on-chip (SoCs), also referred to herein as HiLITE.

FIG. 2 is a graphical representation of decision tree accuracy as DAgger iteratively trains policies using leave-one-out (LOO) cross-validation for each application.

FIG. 3 is a graphical representation of a normalized histogram with respect to total predictions for frequency (π_{freq}) and number of cores (π_{cores}).

FIG. 4A is a graphical representation of a normalized energy-delay product (EDP) with respect to performance governor.

FIG. 4B is a graphical representation of a normalized execution time with respect to performance governor.

FIG. 4C is a graphical representation of a normalized energy consumption with respect to performance governor.

FIG. 5 is a graphical representation of a normalized EDP and percentage of missed deadlines for different techniques and deadline thresholds.

FIG. 6 is a block diagram of a computer system suitable for implementing HiLITE according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Hierarchical and lightweight imitation learning (IL) for power management of embedded systems-on-chip (SoCs), also referred to herein as HiLITE, is provided. Modern SoCs use dynamic power management (DPM) techniques to improve energy efficiency. However, existing techniques are unable to efficiently adapt the runtime decisions considering multiple objectives (e.g., energy and real-time requirements) simultaneously on heterogeneous platforms. To address this need, embodiments described herein propose HiLITE, a hierarchical IL framework that maximizes energy efficiency while satisfying soft real-time constraints on embedded SoCs.

This approach first trains DPM policies using IL; then, it applies a regression policy at runtime to minimize deadline misses. HiLITE improves the energy-delay product by 40% on average, and reduces deadline misses by up to 76%, compared to state-of-the-art approaches. In addition, the trained policies not only achieve high accuracy, but also have negligible prediction time overhead and small memory footprint.

### I. Introduction

The present disclosure proposes HiLITE, a hierarchical DPM framework that uses IL to minimize the energy-delay product (EDP), while coping with soft real-time (RT) constraints in SoCs. To this end, an oracle is first constructed using power and performance data of domain-specific applications, namely wireless communications and radar systems. Then, IL policies are trained to achieve low EDP while considering soft deadlines, by adjusting the frequency and number of active cores in LITTLE and big clusters.

An offline trained policy can set the operating point successfully for energy optimization, but it may miss deadlines due to the unpredictable dynamic variations of the workload and scheduling. Therefore, the present disclosure further proposes a novel online regression policy that fine-tunes the policy decisions to address these variations.

Embodiments described herein can provide the following advantages:
A hierarchical framework that comprises lightweight IL policies to maximize energy-efficiency and a regression policy for fine-tuning the SoC configuration to meet RT constraints.
Design- and run-time approaches for coping with execution deadlines, while optimizing the energy consumption.
Validation of the simulation results against a commercial SoC with respect to performance, power, and temperature.

### II. Hierarchical Deadline-Aware DPM

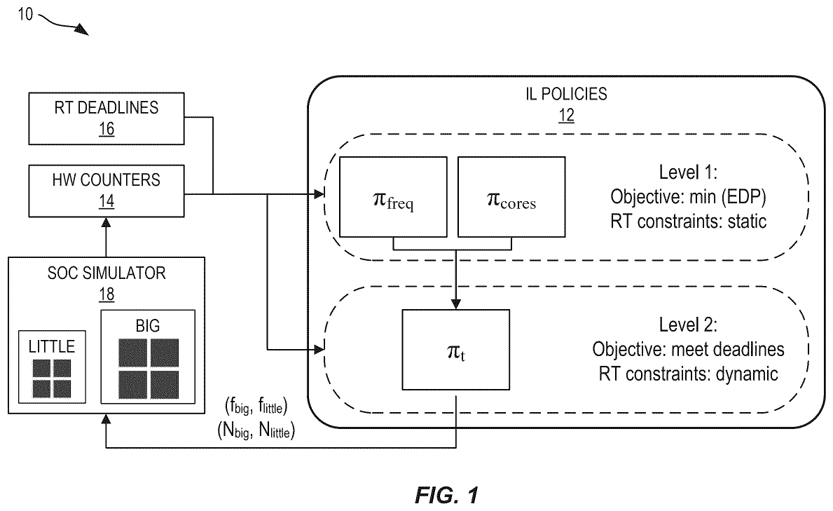

FIG. 1 is a schematic diagram of an exemplary embodiment of HiLITE 10. This section presents oracle generation methodology and deadline-aware IL policies 12 in HiLITE 10 as illustrated in FIG. 1.

### A. Oracle Generation

To characterize the impact of the power management configuration (e.g., cluster frequencies) on system performance and energy consumption and to enable Oracle generation, microbenchmarks are constructed that consist of a fixed number of frames. The frames are the basic unit of data processed by each application, so each frame contains 64 bits for most target applications. Each microbenchmark is run on the Odroid-XU3 board for each supported configuration and store performance counters, execution time, and power consumption. Therefore, this methodology preserves the workload when evaluating microbenchmarks with different frequency levels and number of cores. In evaluations, each microbenchmark consists of ten frames and is long enough to collect reliable statistics. The frames within each microbenchmark are executed in parallel based on the availability of resources and the rate at which they are injected into the system. Finally, a workload is a collection of such microbenchmarks.

All possible combinations are evaluated for ten frames in a microbenchmark with five applications (presented in Section III-B), resulting in 1001 unique microbenchmarks. Each of these microbenchmarks is evaluated with all combinations of frequency states: eight for the big cluster (0.6-2.0 GHz) and five for the LITTLE (0.6-1.4 GHz), using a 200 MHz step, and all number of cores (1-4 big and 1-4 LITTLE); this results in more than 640K samples. Based on these samples, the oracle chooses the configuration that minimizes the EDP of each microbenchmark, while considering the RT constraints. The oracle (π*_{K} for each microbenchmark k is expressed in Equation 1 as:

$${π}_{k}^{*} = arg {min}_{{C}_{i} ∈ C} \{ {E}_{k} ( {C}_{i} ) \times {t}_{k} ( {C}_{i} ) \} \qquad ( 1 )$$

$$s . t . {t}_{k} ( {C}_{i} ) \leq {D}_{k} ,$$

$$k = 1 , 2 , … ( \begin{matrix}F + A - 1 \\ A - 1\end{matrix} )$$

where C represents all possible combinations of frequency points and number of cores (fₚₒᵢₙₜₛ(LITTLE)×fₚₒᵢₙₜ(big)×N_{cores}(LITTLE)×N_{cores}(big)). The index k represents each unique microbenchmark based on the binomial coefficient of F frames per microbenchmark and A applications. Eₖ(Cᵢ) and tₖ(Cᵢ) denote the energy consumption and execution time of a given microbenchmark at configuration Cᵢ, respectively. Finally, Dₖ is the deadline of microbenchmark k.

The oracle generates two tuples in the following format: (f_{big}, fₗᵢₜₜₗₑ), (N_{big}, Nₗᵢₜₜₗₑ), for the policies predicting the frequency and number of cores, respectively. Similarly, for the regression policy, the measured execution time is used as the oracle.

### B. Imitation Learning Policies

Exact imitation trains a policy that closely follows the oracle. However, it may suffer from error propagation, i.e., errors in previous states affect the decisions for the next ones. To address this issue, an IL approach called DAgger is employed, which is applied to all three proposed policies (prediction of frequencies, number of cores, and execution time). More precisely, at every control interval (typically 50-100 ms), the IL policy 12 makes a prediction, which is applied to the system and compared against the oracle. If the prediction differs from the oracle, this sample is aggregated to the dataset and the execution continues. No action is taken if the prediction aligns with the oracle. After the execution finishes, the aggregated dataset is used to retrain the IL policy 12 in order to teach the IL policy 12 to learn from the mistakes made during the previous iterations.

Table 1 presents the features that are used to train the IL policies 12. These hardware counters 14 are normalized to the number of instructions in order to generalize to other applications with similar characteristics.

TABLE 1
Features for training the IL policies

| | | | |
|---|---|---|---|
| Current | Number active cores (big | HW | CPU cycles |
| state | cluster) | counters | Branch |
| | Number active cores | | misprediction |
| | (LITTLE cluster) | | L2 cache misses |
| | Frequency big cluster | | Data memory access |
| | Frequency LITTLE | | Non-cache external |
| | cluster | | mem. req. |

### C. Runtime Management of Deadline Constraints

Both design- and run-time techniques are proposed to cope with deadline constraints. More precisely, at the design time, the oracle generation is modified to consider RT deadline constraints 16, as in Equation 1. At runtime, a hierarchical approach is employed to estimate the execution time, which addresses the workload runtime variations.

Algorithm 1 depicts the proposed hierarchical structure of HiLITE 10; this algorithm is applied at each control interval. First, the IL policies 12 get the current system state and hardware counters 14, then perform the inference for the frequency and number of cores. The regression policy is activated only if the microbenchmark has a deadline. Then, the predicted execution time t_{pred} (line 8 in Algorithm 1) is compared against the deadline; if the predicted execution time is greater than the deadline Dₖ, the following measures are applied: 1) increase the frequency/voltage of the big and LITTLE clusters by one increment (lines 12-13), and 2) if the frequency is already at the maximum for both clusters, increase the number of active cores by one (line 17). Otherwise, if the predicted time does not exceed the deadline, the execution continues following the level 1 IL policies 12. Power gating (PG) is applied to the inactive cores of each cluster. The frequency is increased first because turning on an additional core incurs more overhead than increasing the frequency of an active core.

Algorithm 1: Hierarchical structure of HiLITE

| | /* Level 1 */ | | | | | |
|---|---|---|---|---|---|---|
| 1 | s ← get current state and hardware counters | | | | | |
| 2 | foreach Clᵢ in Clusters do | | | | | |
| 3 | \| | f(Clᵢ) ← π_{freq}(s)[Clᵢ] | | | | |
| 4 | \| | V(Clᵢ) ← voltage point w.r.t. f(Clᵢ) | | | | |
| 5 | \|_ | cores(Clᵢ) ← π_{cores}(s)[Clᵢ] | | | | |
| | */ Level 2 */ | | | | | |
| 6 | if workload has real-time constraints then | | | | | |
| 7 | \| | s ← get current state and hardware counters | | | | |
| 8 | \| | t_{pred}(k) ← πᵢ(s) | | | | |
| 9 | \| | if t_{pred}(k) > Dₖ then | | | | |
| 10 | \| | \| | foreach Clᵢ in Clusters do | | | |
| 11 | \| | \| | \| | if f(Clᵢ) < max {f(Clᵢ)} then | | |
| 12 | \| | \| | \| | \| | f(Clᵢ) ← next frequency point of Clᵢ | |
| 13 | \| | \| | \| | \|_ | V(Clᵢ) ← next voltage point of Clᵢ | |
| | \| | \| | \|_ | | | |
| 14 | \| | \| | if ∀Clᵢ in Clusters, f(Clᵢ) = max{f(Clᵢ)} then | | | |
| 15 | \| | \| | \| | foreach Clᵢ in Clusters do | | |
| 16 | \| | \| | \| | \| | if cores(Clᵢ) < max{cores(Clᵢ)} then | |
| 17 | \| | \| | \| | \| | \|_ | cores(Clᵢ) ← cores(Clᵢ) + 1 |

| | | | |
|---|---|---|---|
| \| | \| | \| | \|_ |

| | | |
|---|---|---|
| \| | \| | \|_ |

| | |
|---|---|
| \| | \|_ |

| | |
|---|---|
| | \|_ |
| 18 | ∀Clᵢ in Clusters, apply PG to the inactive cores of Clᵢ |

As the hierarchical approach is applied at runtime, the frequency and number of cores are fine-tuned only if necessary. If this methodology is applied entirely at design-time, the oracle decisions overestimate the required frequency and number of cores for all samples, to achieve the same level of deadline misses from the hierarchical approach. This increases the EDP by around 20% with respect to the hierarchical IL policies 12. Hence, the hierarchical approach addresses these issues by providing a generic and more efficient solution at runtime.

### III. Evaluation Results

### A. Methodology and Evaluation Setup

Since embodiments focus on lightweight IL techniques, decision trees are used for level 1 and a regression tree is used for level 2 to achieve fast training and inference. For training, leave-one-out cross-validation is used to completely remove frames from a specific application from the dataset. Then, a workload that contains frames from the removed application is run to test the model generalization to unseen applications. For testing, workloads with 50 microbenchmarks are considered and executed 5 times (standard deviation of less than 1%). For each execution, 10 DAgger iterations are applied.

Two main scenarios are evaluated with the target applications: 1) Regular workload of a communication system, having an average of 1.25 frames being processed in parallel with up to 5 parallel frames; and 2) Heavy workload with 3 parallel frames on average and up to 8 frames (i.e., 100% utilization as there are 8 cores in total).

The proposed approach is tested under different RT-constrained scenarios by generating bounded random deadlines (Dₖ) for each microbenchmark. This allows the generation of deadline constraints based on profiled requirements instead of manually inputting the deadline for each microbenchmark, hence, allowing a flexible evaluation of different scenarios. To achieve this, a random number R is generated from a uniform distribution U between a specified low (D_{TLow}) and high (D_{THigh}) thresholds. These thresholds can range from 0% to 100%. Then, R is multiplied by the range of the microbenchmark's execution time and add the minimum execution time min_{C}_{ᵢ}_{ϵC}{tₖ(Cᵢ}. So, the deadline for microbenchmark k is given by Equation 2:

$${D}_{k} = {min}_{{C}_{i} ∈ C} \{ {t}_{k} ( {C}_{i} ) \} + ( R \sim U ( [ {D}_{TLow} , {D}_{THigh} ] ) \div 100 ) \times ( {max}_{{C}_{i} ∈ C} \{ {t}_{k} ( {C}_{i} ) \} - {min}_{{C}_{i} ∈ C} \{ {t}_{k} ( {C}_{i} ) \} ) \qquad ( 2 )$$

The following deadline ranges are evaluated: D_{T}=0-5%, D_{T}=5-10%, and D_{T}=10-20%, in decreasing order of difficulty to satisfy.

### B. Simulation Framework Overview and Validation

The system-level SoC simulator 18 proposed in S. E. Arda et al., “DS3: A System-Level Domain-Specific System-on-Chip Simulation Framework,” in IEEE Transactions on Computers, vol. 69, no. 8, pp. 1248-1262, 2020 (referred to hereinafter as “DS3,” the disclosure of which is incorporated herein by reference in its entirety) is extended to incorporate the proposed IL technique.

Platform Model: To ensure high fidelity, the simulator 18 is calibrated using the performance monitoring unit (PMU), current and temperature sensors of the Odroid-XU3. This board allows changing the frequencies only at the cluster level and does not apply PG. To make the design more flexible and explore better power/performance tradeoffs, a per-core PG technique is implemented in the simulator 18.

Benchmark Applications: Five multi-threaded reference applications are considered from wireless communications and radar processing domains: WiFi transmitter (WiFi-TX), WiFi receiver (WiFi-RX), range detection (Range-Det), single-carrier transmitter (SCT), and single-carrier receiver (SCR). All these are representative examples of streaming applications with soft RT constraints.

Data Collection: The applications' source code is instrumented with performance application programming interface (PAPI) calls to profile power, performance, and hardware counter data on the Odroid-XU3.

Execution time, power, and temperature reported by the simulator 18 are compared against measurements on an Odroid-XU3, while running the benchmark applications. The simulator 18 has only 2.8%, 6.1%, and 2.4% error, on average, for these three metrics when the LITTLE and big core frequencies are swept for multi-threaded applications. Similarly, when sweeping the different number of cores results in 2.7%, 1.3%, and 3.8% error on average, respectively. The complete evaluation for both single- and multi-threaded applications and the validation data can be found in DS3.

### C. Accuracy Evaluation

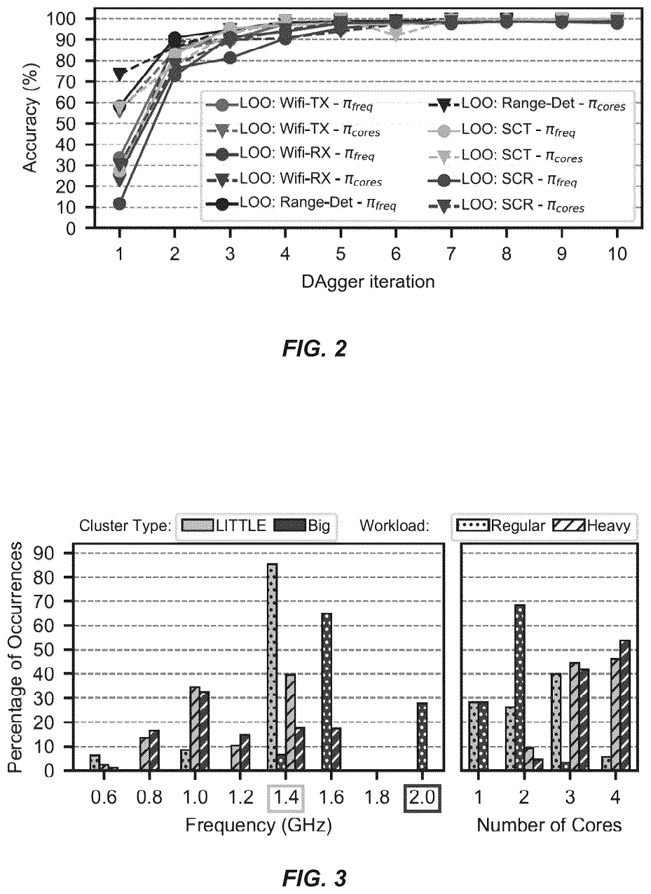

FIG. 2 is a graphical representation of decision tree accuracy as DAgger iteratively trains policies using leave-one-out (LOO) cross-validation for each application. The decision tree quickly learns as DAgger iterations are applied and achieves 99.1% accuracy on average. The accuracy at the first iteration ranges from 11.8% to 73.3%, and by the fourth iteration, all policies are already above 90%. The regression policy (level 2) achieves an R2 metric of 99.7%, closely following the oracle. The policies take from 0.013 ms to 0.617 ms per prediction, which is negligible over 50-100 ms control epochs. Likewise, the memory requirements range from 3 KB to 280 KB.

FIG. 3 is a graphical representation of a histogram normalized with respect to total predictions for frequency (π_{freq}) and number of cores (π_{cores}). The circled frequencies depict the maximum frequency for LITTLE (1.4 GHz) and big (2 GHz) clusters. Each bar represents a combination of cluster type and workload, i.e., the LITTLE and big clusters are depicted in different colors, while the regular and heavy workloads are depicted with different patterns. When running a regular load, π_{freq} chooses 85% of the time the maximum frequency for the LITTLE (i.e., 1.4 GHz), and high frequencies for the big cluster (65% at 1.6 GHz and 28% at 2 GHz). At the same time, π_{cores} chooses more than 95% of the time three or fewer LITTLE cores and two or fewer big cores. This shows that the policies effectively shut down cores when the workload is not heavy. For heavy workloads, the frequencies lie mostly within 0.8 GHz to 1.6 GHz, and π_{cores} chooses mostly 3 and 4 cores (around 90% of the time), such that the EDP is minimized as several frames are processed in parallel.

D. Comparison with State-of-the-Art Techniques

The approach described herein is compared against performance, powersave, ondemand, and DyPO. The first three belong to the Linux governors and the latter uses machine learning to adjust frequency and number of cores. Two versions of HiLITE are evaluated: first, by only changing the frequency of the clusters (HiLITE_{(F)}, and second, by changing both frequency and number of cores (HiLITE_{(F-C)}).

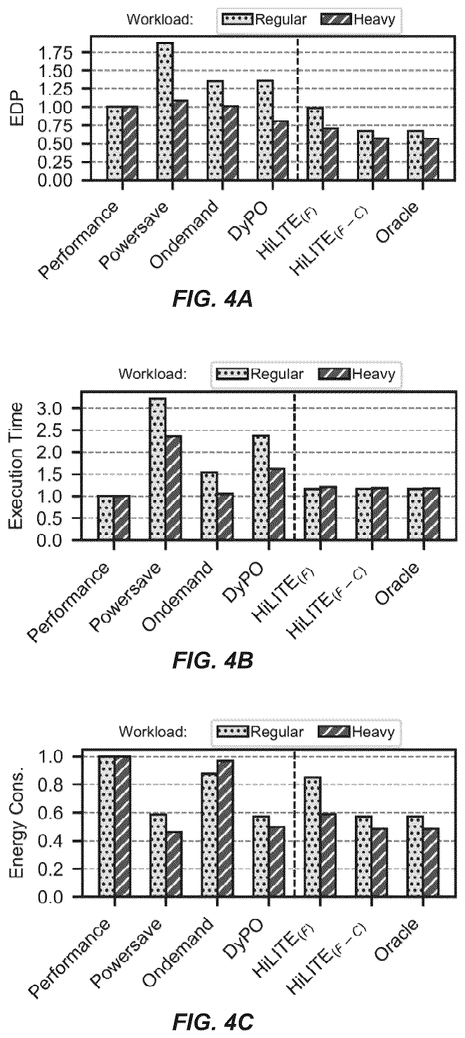

EDP Evaluation: FIG. 4A is a graphical representation of a normalized EDP with respect to performance governor. HiLITE_{(F)} achieves 2% and 29% reduction for regular and heavy workload scenarios, respectively. The former case leads to smaller improvement since the oracle frequency is high for most of the execution, as discussed above with respect to FIG. 3. When HiLITE_{(F-C)} is applied, the EDP improvement rises to 34% and 43% with respect to the performance governor, for the same runtime scenarios. Compared to DyPO, HiLITE_{(F-C)} achieves 51% and 29% lower EDP under regular and heavy workloads, respectively. DyPO is not able to efficiently explore such a large design space since it employs logistic regression followed by k-means clustering; also, DyPO does not exploit PG to further improve the energy efficiency. In addition, HiLITE_{(F-C)} closely follows the Oracle, being within 0.4% of the Oracle's mark, which is the upper bound for comparison.

Execution Time Evaluation: FIG. 4B is a graphical representation of a normalized execution time with respect to performance governor. HiLITE achieves low performance degradation with respect to the performance mode (16%-21%). While the other baselines have considerably higher degradation: powersave 136-221%, ondemand 5-54%, and DyPO 61-137%.

Energy Consumption Evaluation: FIG. 4C is a graphical representation of a normalized energy consumption with respect to performance governor. HiLITE_{(F-C)} achieves 43% and 52% energy savings with respect to the performance mode under a regular and heavy workload, respectively.

### E. Evaluations Under Real-Time Constraints

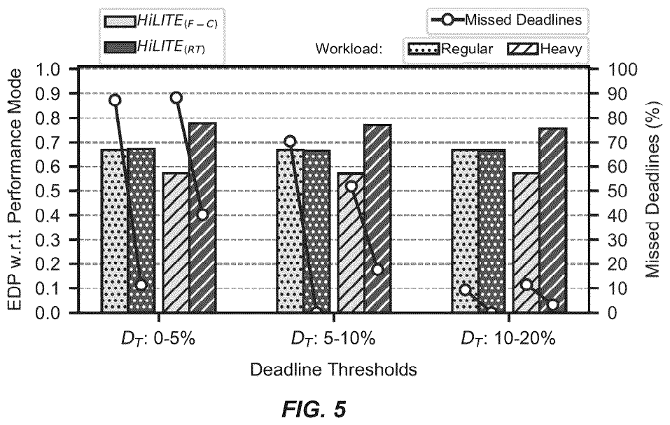

FIG. 5 is a graphical representation of a normalized EDP and percentage of missed deadlines for different techniques and deadline thresholds. As DyPO has considerably higher performance degradation than HiLITE_{(F-C)} (this leads to even higher deadline misses), HiLITE_{(F-C)} is chosen as the baseline. HiLITE_{(RT)} represents HiLITE with RT optimization enabled, and under DT=0-5% (i.e., tightest deadlines); this reduces the deadline misses from 87% to 11%, and from 88% to 40% for regular and heavy workloads, respectively. The reduction in the latter case is lower due to multiple frames being processed in parallel. The same trend is observed for D_{T}=5-10%, for the regular workload (70% deadline misses are reduced to 0%) and for the heavy workload (52% to 17%). Further relaxation of these deadline constraints drives the missed deadlines towards zero for both workloads.

For regular workloads, the EDP overhead is low, only 2% on average, while under a heavy workload, there is a trade-off between minimizing the EDP and meeting the deadlines. If the deadlines are prioritized, the EDP improvement goes from 43% to 25%, as the frequency needs to be increased to meet the deadlines.

This evaluation shows that generating an oracle without RT information leads to a high number of deadline misses (close to 90%). In contrast, the proposed approach adds the RT information to the oracle generation and uses a dynamic regression policy to address the runtime variation in the execution time.

### IV. Computer System

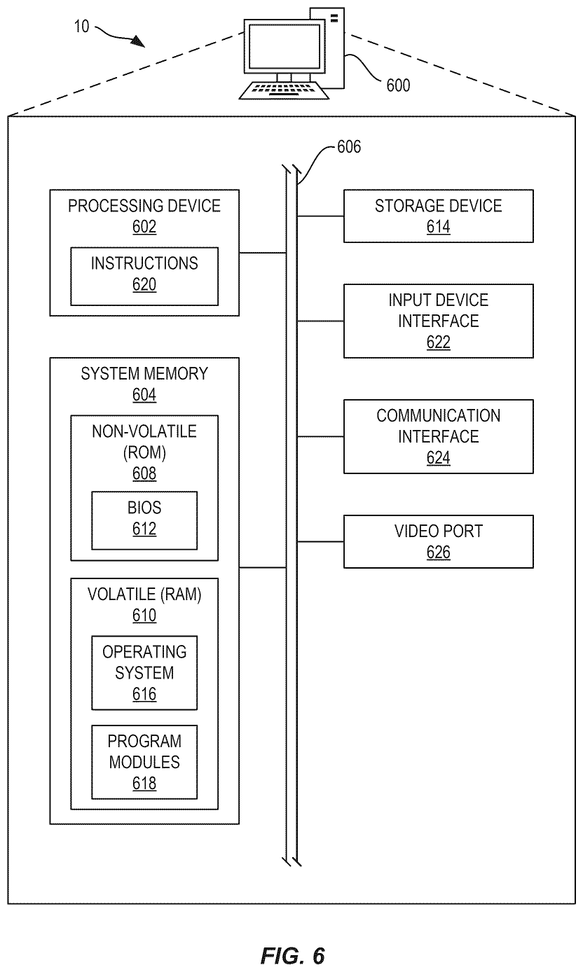

FIG. 6 is a block diagram of a computer system 600 suitable for implementing HiLITE 10 according to embodiments disclosed herein. Embodiments described herein can include or be implemented as the computer system 600, which comprises any computing or electronic device capable of including firmware, hardware, and/or executing software instructions that could be used to perform any of the methods or functions described above. In this regard, the computer system 600 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 600 in this embodiment includes a processing device 602 or processor, a system memory 604, and a system bus 606. The system memory 604 may include non-volatile memory 608 and volatile memory 610. The non-volatile memory 608 may include read-only memory (ROM), erasable programmable read-only memory (EPROM), electrically erasable programmable read-only memory (EEPROM), and the like. The volatile memory 610 generally includes random-access memory (RAM) (e.g., dynamic random-access memory (DRAM), such as synchronous DRAM (SDRAM)). A basic input/output system (BIOS) 612 may be stored in the non-volatile memory 608 and can include the basic routines that help to transfer information between elements within the computer system 600.

The system bus 606 provides an interface for system components including, but not limited to, the system memory 604 and the processing device 602. The system bus 606 may be any of several types of bus structures that may further interconnect to a memory bus (with or without a memory controller), a peripheral bus, and/or a local bus using any of a variety of commercially available bus architectures.

The processing device 602 represents one or more commercially available or proprietary general-purpose processing devices, such as a microprocessor, central processing unit (CPU), or the like. More particularly, the processing device 602 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 602 is configured to execute processing logic instructions for performing the operations and steps discussed herein.

In this regard, the various illustrative logical blocks, modules, and circuits described in connection with the embodiments disclosed herein may be implemented or performed with the processing device 602, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 602 may be a microprocessor, or may be any conventional processor, controller, microcontroller, or state machine. The processing device 602 may also be implemented as a combination of computing devices (e.g., a combination of a DSP and a microprocessor, a plurality of microprocessors, one or more microprocessors in conjunction with a DSP core, or any other such configuration).

The computer system 600 may further include or be coupled to a non-transitory computer-readable storage medium, such as a storage device 614, which may represent an internal or external hard disk drive (HDD), flash memory, or the like. The storage device 614 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 616 and any number of program modules 618 or other applications can be stored in the volatile memory 610, wherein the program modules 618 represent a wide array of computer-executable instructions corresponding to programs, applications, functions, and the like that may implement the functionality described herein in whole or in part, such as through instructions 620 on the processing device 602. The program modules 618 may also reside on the storage mechanism provided by the storage device 614. As such, all or a portion of the functionality described herein may be implemented as a computer program product stored on a transitory or non-transitory computer-usable or computer-readable storage medium, such as the storage device 614, volatile memory 610, non-volatile memory 608, instructions 620, and the like. The computer program product includes complex programming instructions, such as complex computer-readable program code, to cause the processing device 602 to carry out the steps necessary to implement the functions described herein.

An operator, such as the user, may also be able to enter one or more configuration commands to the computer system 600 through a keyboard, a pointing device such as a mouse, or a touch-sensitive surface, such as the display device, via an input device interface 622 or remotely through a web interface, terminal program, or the like via a communication interface 624. The communication interface 624 may be wired or wireless and facilitate communications with any number of devices via a communications network in a direct or indirect fashion. An output device, such as a display device, can be coupled to the system bus 606 and driven by a video port 626. Additional inputs and outputs to the computer system 600 may be provided through the system bus 606 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

1.-20. (canceled)

21. A method, comprising:
predicting, during run time, using one or more imitation learning policies, a first hardware configuration for a heterogeneous system-on-chip (SoC), for execution of a first application task, and
executing the first application task, using the heterogeneous SoC with a second hardware configuration, the second hardware configuration being based on the first hardware configuration.

22. The method of claim 21, wherein the second hardware configuration is the same as the first hardware configuration.

23. The method of claim 22, wherein the hardware configuration includes:
a first number of active cores of a first cluster of cores of the SoC; and
a frequency of operation of the active cores.

24. The method of claim 23, wherein the hardware configuration further includes an operating voltage of each of the active cores.

25. The method of claim 22, further comprising:
predicting, using the imitation learning policies, an execution time for the first application task, for execution using the first hardware configuration;
determining that the execution time is less than a deadline for the task; and
based on the determining, selecting the second hardware configuration to be the same as the first hardware configuration.

26. The method of claim 25, wherein:
the one or more imitation learning policies comprise a regression tree, and
the predicting of the execution time comprises predicting the execution time using the regression tree.

27. The method of claim 21, further comprising:
predicting, using the imitation learning policies, an execution time for the first application task, for execution using the first hardware configuration;
determining that the execution time is greater than a deadline for the task; and
based on the determining, selecting the second hardware configuration to be different from the first hardware configuration.

28. The method of claim 27, wherein:
the first hardware configuration includes a first frequency of operation of a first core;
the second hardware configuration includes a second frequency of operation of the first core; and
the second frequency of operation is greater than the first frequency of operation.

29. The method of claim 28, wherein the first hardware configuration includes a first operating voltage for the first core;
the second hardware configuration includes a second operating voltage for the first core; and
the second operating voltage is greater than the first operating voltage.

30. The method of claim 28, wherein:
the first hardware configuration includes a first number of active cores of a first cluster of cores, the first cluster including the first core;
the second hardware configuration includes a second number of active cores of the first cluster; and
the second number is greater than the first number.

31. The method of claim 30, further comprising:
determining that the first hardware configuration includes a respective first frequency of operation of each of a plurality of cores, the respective first frequency of operation of each of the cores being a maximum frequency of operation of the respective core, and
based on the determining that the first hardware configuration includes a respective first frequency of operation of each of a plurality of cores, the respective first frequency of operation of each of the cores being a maximum frequency of operation of the respective core, selecting the second number to be greater than the first number.

32. The method of claim 21, wherein the predicting comprises predicting based on an energy-delay product.

33. The method of claim 21, wherein:
the one or more imitation learning policies comprise a decision tree, and
the predicting comprises predicting the first hardware configuration using the decision tree.

34. The method of claim 21, further comprising constructing the imitation learning policies.

35. The method of claim 34, wherein the constructing of the imitation learning policies comprises:
generating an oracle, and
training an imitation learning policy based on the oracle.

36. The method of claim 35, wherein the generating of the oracle comprises evaluating a benchmark on a first core of a first cluster of cores of the SoC, with a plurality frequencies of operation.

37. The method of claim 36, wherein the generating of the oracle further comprises evaluating the benchmark on a first number of cores of the SoC, and on a second number of cores of the SoC.

38. The method of claim 37, wherein the generating of the oracle further comprises selecting a hardware configuration with a minimum energy-delay product.

39. The method of claim 35, wherein the training of the imitation learning policy comprises:
performing a first phase of training of the imitation learning policy using a first subset of benchmarks of the oracle; and
performing a second phase of training of the imitation learning policy, the performing of the second phase of training comprising:
making a prediction, by the imitation learning policy, for a first benchmark not in the first subset;
determining that the prediction differs from the oracle; and
based on determining that the prediction differs from the oracle, retraining the imitation learning policy, using the first subset and the first benchmark.

40. The method of claim 39, comprising:
performing the second phase of training of the imitation learning policy at a first time, and
performing the second phase of training of the imitation learning policy at a second time, the second time being later than the first time by at most 100 milliseconds.
